(19) United States
(12) Patent Application Publication
(10) Pub. No.: US 2026/0189411 A1
(43) Pub. Date: Jul. 2, 2026

(54) SECURING PROOF-OF-WORK INTEGRITY

(71) Applicant: GREENNET ENERGY SP. Z O. O., TORUN (PL)

(72) Inventor: TONI LUKKAROINEN, PORI (FI)

(21) Appl. No.: 19/057,634

(22) Filed: Feb. 19, 2025

(30) Foreign Application Priority Data
Dec. 31, 2024 (EP) 24223875

(51) Int. Cl. H04L 9/00

(52) U.S. Cl. CPC H04L 9/50

(57) ABSTRACT

A method for enhancing the security and integrity of Proof-of-Work (PoW) systems in blockchain networks. The method securely validates the full PoW computation, ensuring that miners perform the intended algorithmic steps rather than exploiting shortcuts or using nonces derived from different algorithms. By embedding cryptographic proofs within the PoW verification process, the method prevents tampering and manipulation, enhancing the transparency, security, and trustworthiness of PoW-based blockchain systems. This method strengthens the consensus mechanism and protects the network from malicious actors, ensuring the integrity of the blockchain.

### CROSS-REFERENCE

This application claims priority to European application number EP 24223875 filed Dec. 31, 2024, which is incorporated-by-reference herein.

### FIELD

The disclosure relates to the field of cryptographic blockchain technology, with a particular focus on improving the integrity of Proof-of-Work (PoW) mechanisms. Specifically, it addresses the transfer and validation of PoW hashes in distributed networks, enabling streamlined verification of computational effort and robust consensus in decentralized systems.

### BACKGROUND

In Bitcoin and other PoW blockchains, miners solve cryptographic puzzles to add new blocks, involving the discovery of a nonce. This nonce, when combined with block data and processed through a hashing algorithm, produces a hash that meets the network's difficulty target. Nodes validate the block by recalculating the hash using the provided nonce. However, nonce-based validation has security limitations, as multiple valid nonces can lead to a valid block, and a valid nonce can be found without doing the actual proof of work with nonce guessing methods, allowing attackers to manipulate the process without detection. This reduces transparency and increases the risk of exploits.

We tested this vulnerability using Pyrinhash V1 and V2 algorithms, mining with one and generating nonces valid for the other. This showed that a valid nonce could be created without the intended computation, exposing flaws in nonce-based validation. To address this, we developed a solution that ensures the integrity of the entire PoW process by securely validating the entire hash, preventing manipulation of intermediate steps and misuse of nonces from different algorithms. This solution strengthens the security and trustworthiness of PoW-based blockchain systems.

The foregoing examples of the related art and limitations therewith are intended to be illustrative and not exclusive. Other limitations will become apparent to those skilled in the art upon a reading of the specification and a study of the drawings.

### PURPOSE

One purpose of the disclosure is to provide a more secure and reliable method for validating Proof-of-Work (PoW) in blockchain systems, specifically by ensuring the integrity of the entire computation process rather than relying solely on the validity of the nonce. In current blockchain systems that utilize PoW, the process of validation is based on the discovery of a valid nonce that, when combined with other block data, results in a hash that meets the network's target difficulty. However, this validation mechanism is vulnerable to manipulation, as it does not independently confirm the correctness of the entire PoW process.

By addressing the limitations and vulnerabilities associated with nonce-based validation, the disclosure aims to enhance the security of PoW-based systems, making it more difficult for malicious actors to manipulate the hashing process or use alternative shortcuts. The disclosure proposes a method for securely and efficiently validating the entire PoW hash to ensure that miners have executed the full intended computation, thereby preserving the integrity of the blockchain network and preventing exploitation or attacks. The preservation of integrity comes from the fact that the submitter and recipient create a PoW hash with same input data, and the recipient checks that its PoW hash matches the submitter's PoW hash.

### SUMMARY

A method for ensuring the integrity of Proof-of-Work (PoW) in a decentralized network according to the disclosure may comprise the following steps. A miner submits a PoW hash, a block template and a nonce to a node. The node, based on the block template and the nonce received from the miner, calculates a new PoW hash and verifies if the PoW hash received from the miner matches the new PoW hash it computed itself. The node checks that the received PoW hash is below or equal to the network's target, and once a valid block is created, the node relays the valid block, along with the received PoW hash, and the nonce to other nodes within the decentralized network. The nodes are adapted to verify that the received block PoW hash matches their computed PoW hash.

Preferably, instead of submitting the PoW hash, the block template and the nonce to the node, the miner submits the PoW hash, the block template and the nonce to a stratum. The stratum, based on the block template and the nonce received from the miner, calculates a new PoW hash and verifies if the PoW hash received from the miner matches the new PoW hash it computed itself, and then the stratum submits the PoW hash, the block template and the nonce to the node.

In some embodiments, the miner submits the PoW hash via a communication protocol compatible with the stratum or the node for validating the PoW hash matches the PoW hashes calculated by the stratum or the node.

In some embodiments, the PoW hash is transmitted from the miner to the stratum or the node in a manner that preserves the integrity of the submitted PoW hash, preventing tampering during transmission.

The integrity of the PoW hash may be further ensured by maintaining its consistency during the transfer process between the miner, the stratum, and the node.

In some embodiments, the node that receives a valid PoW hash includes the verified PoW hash into the block, ensuring that the block can be verified by other network nodes by comparing the PoW hash with their own computations.

In some embodiments, after verifying the PoW hash, the node propagates the block and PoW hash to other network nodes, which are independently adapted to verify the PoW hash.

The PoW hash may be further verified by other network nodes according to a hash function consistent with the network's consensus rules, ensuring that only valid PoW hashes are accepted.

In some embodiments, at least one network node re-verifies the PoW hash upon receiving the block, ensuring no tampering occurred during transmission or processing.

In another aspect of the disclosure, a decentralized network may be adapted to perform a method according to the disclosure, ensuring the integrity of Proof-of-Work (PoW).

In some embodiments, a decentralized network ensuring the integrity of Proof-of-Work comprises a plurality of nodes adapted to verify that the received block PoW hash matches the PoW hash computed by such a node.

The disclosure introduces a method to improve the security and integrity of Proof-of-Work (PoW) systems in blockchain networks by ensuring the entire computational process is validated, rather than relying solely on the validity of the nonce. In traditional PoW-based systems, miners generate a nonce. The nonce is a numerical value that, when combined with block data and hashed, results in a valid hash that meets the network's difficulty target. The validity of this hash is then verified by other nodes in the network by recalculating the hash using the provided nonce and confirming that it meets the target difficulty. However, this is vulnerable to manipulation because it only verifies that the provided nonce produces a valid hash, without independently confirming the steps leading to that hash.

The disclosure addresses these limitations by offering a comprehensive validation of the entire PoW process, rather than merely validating the final hash through nonce verification. Specifically, it ensures that the miner has followed the correct computational steps and adhered to the proper algorithm throughout the PoW process. This prevents the use of shortcuts or exploits, such as the use of nonces derived from different algorithms, which could undermine the system's integrity.

To achieve this, the disclosure proposes a method for securely transferring and validating PoW hashes in a distributed network. The solution involves embedding cryptographic proofs within the PoW verification process that make it impossible for an attacker to bypass or manipulate intermediate computations. This is accomplished through an enhanced hash verification protocol that ensures the integrity of the entire computation, not just the final output hash. By incorporating this method, miners are required to prove that they have completed the intended PoW computation, and not just produce a valid nonce using an alternative approach.

Furthermore, the disclosure aims to maintain transparency and reduce the risk of exploitation by revealing the full computational effort behind the PoW, making it more difficult for malicious actors to manipulate or tamper with the system undetected. It creates a more robust and trustworthy consensus mechanism that is resistant to attacks, such as those where miners use a different algorithm to find valid nonces or otherwise bypass the expected validation process.

This enhances the security of PoW-based blockchain systems by providing a method that prevents the exploitation of nonce validation vulnerabilities, ensuring that the full computational effort behind each block is genuine. The disclosure, therefore, increases the reliability and robustness of blockchain networks, protecting them from potential attacks and enhancing their overall trustworthiness.

In addition to the aforementioned aspects, embodiments and features, further aspects, embodiments and features will become apparent by reference to the following description and accompanying drawings.

### DESCRIPTION OF THE DRAWINGS

The description below makes reference to the accompanying drawings, in which:

FIG. 1 shows a distributed blockchain network;

FIG. 2 illustrates mining process ran by the miner;

FIG. 3 illustrates the validation steps performed by the stratum;

FIG. 4 illustrates the validation steps performed by the node;

FIG. 5 illustrates the validation steps performed by the network node.

It is to be understood that the invention is not limited in application to the details of particular arrangements shown in the drawings, as the invention is capable of other embodiments. Embodiments and figures disclosed herein are to be considered illustrative rather than limiting.

### DETAILED DESCRIPTION

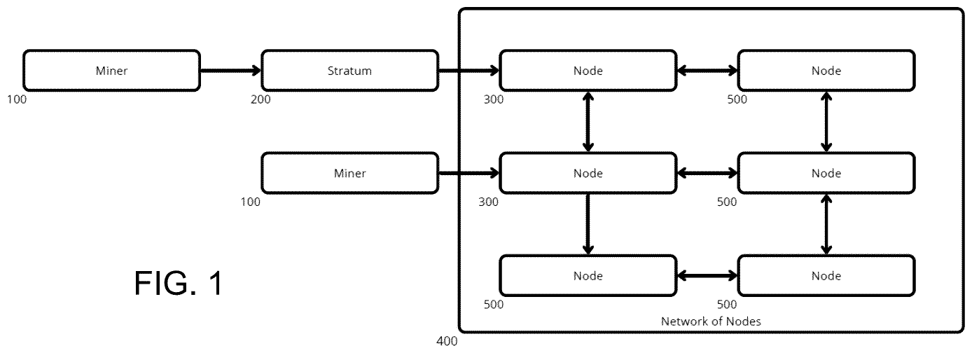

FIG. 1 shows a distributed blockchain network 400 with a miner 100, a stratum 200 and network of nodes 300, 500 with directions for transfer of PoW hash so that it propagates in the network 400.

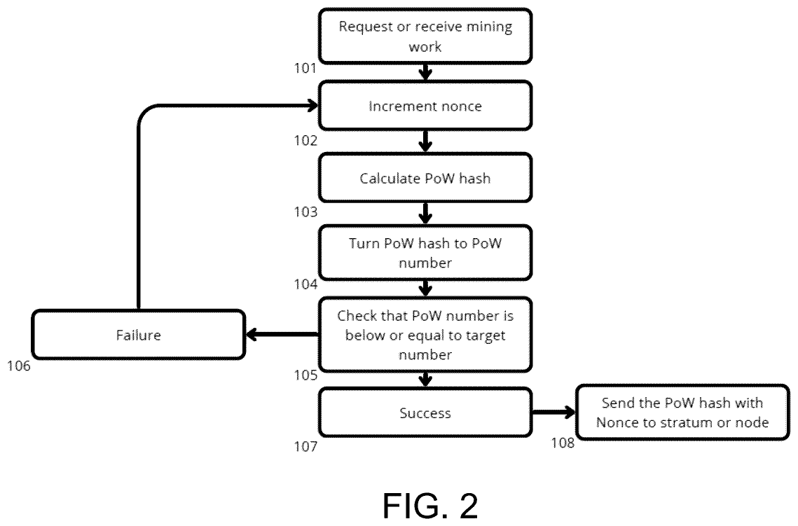

FIG. 2 shows the miner 100 sending the PoW hash 108 with the nonce and block template to the stratum 200 or node 300. The miner receives mining work or request for mining work in step 101 and then begins solving the cryptographic puzzle by incrementing the nonce 102 and calculating the PoW hash 103. Next it calculates a PoW number 104 in order to check the PoW number with the target criteria in the next step 105. The PoW number is the PoW hash turned into a big integer so that it can be compared to be less than or equal to the pool or network target. The target is a big integer number in this case. Using the PoW number is only an example of a target criteria, which is particularly computational effective, since other criteria can be applied to verify PoW done by the miner as the format of the hash calculated, e.g., stating from a certain number of zeros or ones.

If the PoW number is not matching the target criteria, the miner 100 returns to the beginning of the process in step 106, increment the nonce 102 and continue mining. Miners 100 execute the PoW algorithm 103, until they find a nonce that produces a PoW hash meeting the target criteria set by the network 107. The miner 100 submits 108 the PoW hash, along with the nonce and block template, to a stratum server or directly to a node only when the PoW number meets the target criteria. If the PoW algorithm fails 106 and does not generate PoW hash and PoW number that is below or equal to pool or network target, the miner will restart the loop because of failure in finding valid nonce.

Once the stratum 200 or node 300 receives the PoW hash, they turn the PoW hash into the PoW hash number and check that is below or equal to the target.

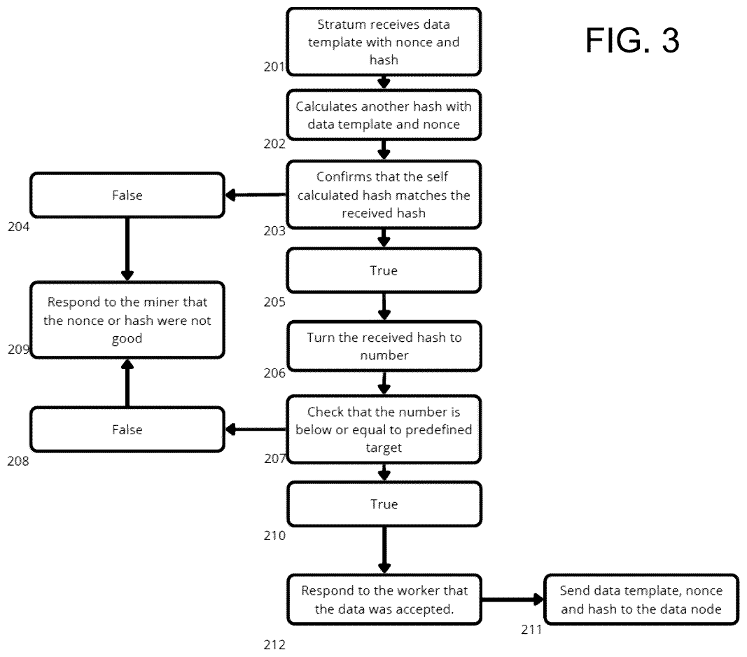

FIG. 3 shows the validation process of the stratum 200 after receiving the PoW hash and nonce 201 from the miner 100, and before submitting the PoW hash and block template with nonce 211 to the node 300. In a preferred embodiment, the stratum 200 recalculates the PoW hash in step 202 using the PoW algorithm with the submitted nonce and block template, afterwards verifying that the self-calculated PoW hash matches the miner's submitted PoW hash in step 203 and that the PoW hash turned into a big integer is below or equal to the network target in steps 206, 207. Upon successful verification in step 205 and 210, the stratum 200 forwards the block to a node 300. Upon failure of verification in step 204 or 208, the stratum 200 cannot accept the block, and the stratum 200 can ban the miner for submitting incorrect PoW hash in step 209.

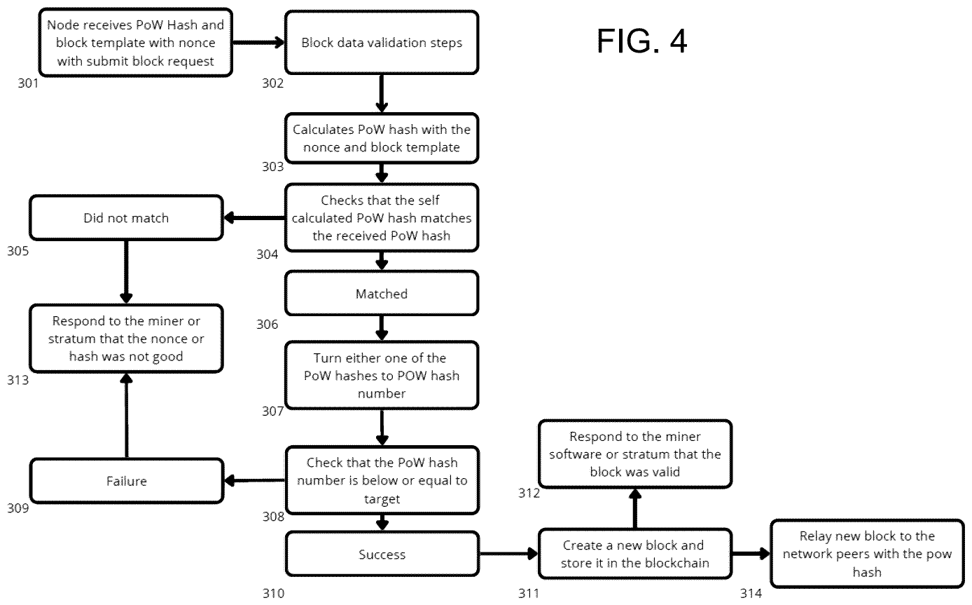

FIG. 4 illustrates the validation process run on the network node 300 after receiving the PoW hash and nonce in step 301 in a submit block request, and before relaying the block 314 to its peer nodes in the network 400. In a preferred embodiment, the node performs the block data validation step 302 and then performs its own validation by recalculating the PoW hash 303, ensuring it matches the submitted hash in steps 304, 305 or 306. Afterwards it turns the PoW hash into PoW number in step 307 and checks that PoW number is below or equal to the network target in step 308. If these and other block creation requirements are met, the process follows steps 310 and 311, the node adds the block to the blockchain in step 311 and relays it to its peers in step 314. If they are not met, the process follows the path of step 305 or 309, the node can ignore the block and ban the miner or stratum for submitting incorrect PoW hash in step 313.

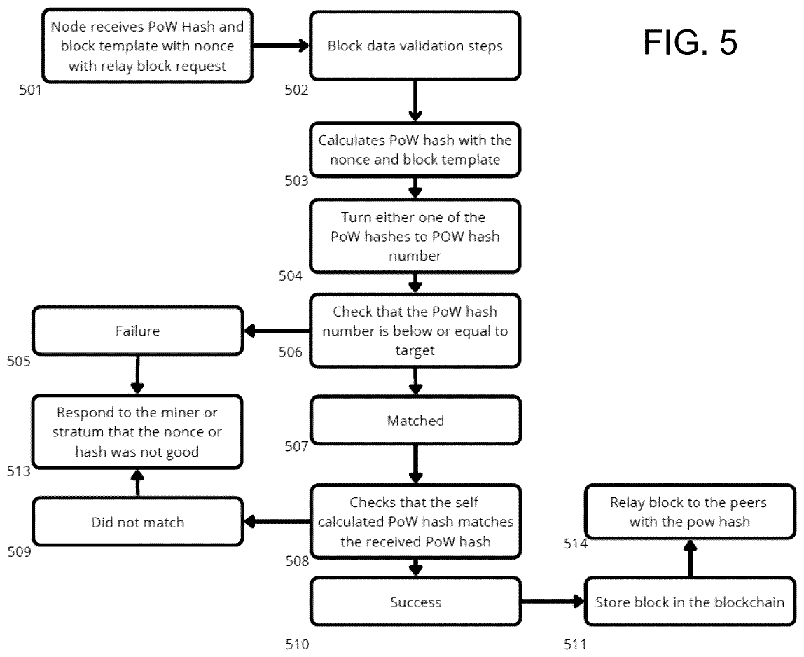

FIG. 5 illustrates the process at network node 500 after receiving the PoW hash and nonce in step 501 in a relay block request, and before relaying the block in step 514 to its peer nodes in the network. In a preferred embodiment, each peer node receives the PoW hash and block template with nonce in step 501 and validates the block in step 502, further verifies the block by recalculating the PoW hash in step 503 and validating the nonce in steps 504, 506. If verification fails the nonce and received PoW hash do not comply with target, the process follows the path via step 505, and the block is returned and the miner is banned 513. Once confirmed the PoW hash number is below or equal to the target in steps 506, 507, and that the self-calculated PoW hash matches the received one in steps 508, 510, the block is added to their local blockchain in step 511 and propagated further across the network in step 514. If they cannot confirm that the self-calculated PoW hash matches the received PoW hash, the process follows the path of step 509, and they can ban the peer which submitted the incorrect PoW hash in step 513.

The disclosure proposes a groundbreaking approach to improving the security and integrity of Proof-of-Work (PoW) mechanisms in blockchain networks. It addresses critical vulnerabilities in existing nonce-based validation systems by ensuring the validation of the entire computational process, not just the nonce. This approach enhances the robustness, transparency, and security of decentralized systems by verifying that all computational steps are correctly executed according to the prescribed PoW algorithm.

Current nonce-based validation merely confirms that a given block template and nonce produce a PoW hash equal to or below the target threshold. However, this process fails to verify whether the miner followed the correct computational steps, leaving the system vulnerable to manipulation. For instance, attackers can exploit this weakness by generating nonces using alternative or invalid algorithms while still producing a valid hash. Such exploits undermine the integrity of the PoW process and allow malicious actors to bypass the computational work intended by the network.

As demonstrated with the Pyrinhash V1 and V2 algorithms, it is possible to generate valid nonces using one algorithm while validating them with another. This bypasses the prescribed computational process, compromising the security of the blockchain. Additionally, the current validation system lacks transparency, as it does not reveal the intermediate steps involved in producing a valid nonce. This creates an environment where shortcuts and exploits can occur undetected.

The disclosure aims to resolve these vulnerabilities by shifting the focus of PoW validation from the nonce alone to the entire computational process. This involves verifying that the miner's calculated PoW hash matches a self-calculated PoW hash based on the submitted block template and nonce. This ensures that miners execute the prescribed algorithm without manipulation or shortcuts. By validating every step of the PoW computation, the use of invalid or alternative algorithms is prevented and the integrity of the network is maintained.

The validation process unfolds in several stages to safeguard the PoW mechanism:
This comprehensive validation ensures that every participant in the network independently verifies the integrity of the PoW computation. By incorporating the entire computational process into the validation, the vulnerabilities associated with nonce-based systems are eliminated. Miners are compelled to perform the intended computations, ensuring compliance with the prescribed algorithm.

The inclusion of PoW hash validation strengthens the consensus mechanism, making it more resistant to attacks and maintaining blockchain integrity. The consistency of data transfer comes from the fact that the submitter and recipient create a PoW hash with same input data, and the recipient checks that its PoW hash matches the submitter's PoW hash.

Transparency is enhanced by revealing the computational steps behind each PoW hash, fostering trust and credibility among network participants. Secure transfer protocols safeguard the integrity of PoW hashes during transmission, preventing tampering between miners, stratums, and nodes. The decentralized nature of validation, with each node independently verifying the PoW process, eliminates reliance on a single point of failure and increases the network's resilience against attacks.

The invention has been described on the basis of one or more example embodiments. Without departing the scope of the claims, numerous further embodiments, permutations, modifications and options for practicing the invention are apparent to those skilled in the art, without these having to be explained or shown in greater detail in the context of this disclosure. The claims should therefore be interpreted to include all such embodiments, permutations, modifications and options, which are within their true spirit and scope. Each embodiment described herein has numerous equivalents.

The terms and expressions which have been employed are used as terms and expressions of description and not of limitation, and there is no intention in the use of such terms and expressions of excluding any equivalents of the features shown or described, or portions thereof, from the scope of the invention. In general, the terms and expressions used herein have their art-recognized meaning, which can be found by reference to standard texts, references and contexts known to those skilled in the art.

1. A method for ensuring the integrity of Proof-of-Work (PoW) in a decentralized network, comprising the steps:
a miner submits a PoW hash, a block template and a nonce to a node,
the node, based on the block template and the nonce received from the miner, calculates a new PoW hash and verifies that the PoW hash received from the miner matches the new PoW hash computed by the node, and
the node checks that the received PoW hash is below or equal to the network's target, and once a valid block is created, the node relays the valid block, along with the PoW hash, and the nonce to other network nodes within the decentralized network, wherein the other network nodes are adapted to verify that the PoW hash received by such a network node matches a PoW hash computed by the network node.

2. The method according to claim 1, wherein the miner submits the PoW hash, the block template and the nonce to the node indirectly through a stratum, further comprising the steps:
the miner submits the PoW hash, the block template and the nonce to the stratum,
the stratum, based on the block template and the nonce received from the miner, calculates a new PoW hash and verifies that the PoW hash received from the miner matches the new PoW hash computed by the stratum, and
the stratum submits the PoW hash, the block template and the nonce to the node.

3. The method of claim 1, wherein the miner submits the PoW hash via a communication protocol compatible with the node for validating the PoW hash matches the PoW hash calculated by the node.

4. The method of claim 1, wherein the PoW hash is transmitted from the miner to the node in a manner that preserves the integrity of the submitted PoW hash, preventing tampering during transmission.

5. The method of claim 1, wherein the integrity of the PoW hash is ensured by maintaining its consistency during the transfer process between the miner, the stratum and the node.

6. The method of claim 1, wherein the node that receives a valid PoW hash includes the verified PoW hash into the block, ensuring that the block can be verified by other network nodes by comparing the PoW hash with their own computations.

7. The method of claim 1, wherein after verifying the PoW hash, the node propagates the block and PoW hash to other network nodes, which are independently adapted to verify the PoW hash.

8. The method of claim 1, wherein the PoW hash is verified by nodes according to a hash function consistent with the network's consensus rules, ensuring that only valid PoW hashes are accepted.

9. The method of claim 1, wherein the network node re-verifies the PoW hash upon receiving the block, ensuring no tampering occurred during transmission or processing.

10. A decentralized network adapted to perform the method of claim 1 for ensuring the integrity of Proof-of-Work (PoW).

11. A method for ensuring the integrity of Proof-of-Work (PoW) in a decentralized network, comprising the steps:
a miner submits a PoW hash, a block template and a nonce to a stratum,
the stratum, based on the block template and the nonce received from the miner, calculates a new PoW hash and verifies that the PoW hash received from the miner matches the new PoW hash computed by the stratum,
the stratum submits the PoW hash, the block template and the nonce to a node,
the node, based on the block template and the nonce received from the stratum, calculates a new PoW hash and verifies that the PoW hash received from the stratum matches the new PoW hash computed by the node, and
the node checks that the received PoW hash is below or equal to the network's target, and once a valid block is created, the node relays the valid block, along with the PoW hash, and the nonce to other network nodes within the decentralized network, wherein the other network nodes are adapted to verify that the PoW hash received by such a network node matches a PoW hash computed by the network node.

12. The method of claim 11, wherein the miner submits the PoW hash via a communication protocol compatible with the stratum for validating the PoW hash matches the PoW hashes calculated by stratum.

13. The method of claim 11, wherein the PoW hash is transmitted from the miner to the stratum or the node in a manner that preserves the integrity of the submitted PoW hash, preventing tampering during transmission.

14. The method of claim 11, wherein the integrity of the PoW hash is ensured by maintaining its consistency during the transfer process between the miner, the stratum and the node.

15. The method of claim 11, wherein the node that receives a valid PoW hash includes the verified PoW hash into the block, ensuring that the block can be verified by other network nodes by comparing the PoW hash with their own computations.

16. The method of claim 11, wherein after verifying the PoW hash, the node propagates the block and PoW hash to other network nodes, which are independently adapted to verify the PoW hash.

17. The method of claim 11, wherein the PoW hash is verified by nodes according to a hash function consistent with the network's consensus rules, ensuring that only valid PoW hashes are accepted.

18. The method of claim 11, wherein the network node re-verifies the PoW hash upon receiving the block, ensuring no tampering occurred during transmission or processing.

19. A decentralized network adapted to perform the method of claim 11 for ensuring the integrity of Proof-of-Work (PoW).

20. A decentralized network for ensuring the integrity of Proof-of-Work (PoW) comprising nodes adapted to verify that a block PoW hash received by such a node matches a PoW hash computed by the node.
